(19) United States
(12) Patent Application Publication
(10) Pub. No.: US 2007/0110140 A1
(43) Pub. Date: May 17, 2007

(54) Automatic selection of coherent and noncoherent transmission in a wireless communication system

(75) Inventors: Paul Howard, Bristol (GB); Alan Edward Jones, Calne (GB); Vishakan Ponnampalam, Clifton (GB)

Correspondence Address: MORRISON & FOERSTER LLP, 12531 HIGH BLUFF DRIVE, SUITE 100, SAN DIEGO, CA, 92130-2040, US

(73) Assignee: IPWireless, Inc., San Bruno, CA (US)

(21) Appl. No.: 11/273,443

(22) Filed: Nov. 14, 2005

(51) Int. Cl. H04B 1/00

(52) U.S. Cl. 375/150

(57) ABSTRACT

A coherent or a noncoherent transmission mode is automatically selected for a transmission on the basis of an estimated Doppler frequency shift due to a motion of a mobile terminal. A coherent mode is selected if a pilot signal overhead is not excessive to uniquely characterize a Doppler frequency shift, as at lower carrier frequency times relative velocity products. A noncoherent mode is selected if a pilot signal overhead would be excessive to uniquely characterize a Doppler frequency shift at higher carrier frequency times relative velocity products. Both the coherent and noncoherent modes have respective advantages for their respective carrier frequency time relative velocity regimes.

### TECHNICAL FIELD

The present invention relates to a method and apparatus for switching between coherent and noncoherent transmission in a wireless communication system, particularly depending on Doppler shift estimates for a roving mobile communication unit.

### DESCRIPTION OF THE RELATED ART

The application of wireless broadband services to high speed trains is a new market. Using standard mobile cellular technology, such as UMTS, acceptable wireless communication performance is typically limited to mobile terminal speeds associated with vehicular applications because of limitations resulting from Doppler shifts. Conventional cellular technology was originally envisaged for car-based vehicular speeds and not high speed trains that travel at substantially higher speeds than cars, typically up to 400 km/h.

The maximum Doppler frequency deviation from the transmitted carrier signal frequency from a base station due to a mobile terminal's movement is given by

$${f}_{m} = \frac{{vf}_{c}}{c} \qquad ( 1 )$$

where f_{c} is the carrier signal frequency, c is the speed of light, and v is the relative velocity between the transmitter and the receiver. Equation (1) shows that the Doppler shift is proportional to both the mobile terminal velocity and the carrier frequency, therefore performance limitations resulting from Doppler effects can also apply at lower terminal velocities if the carrier frequency is higher than that assumed during system conception. Depending on the movement of the mobile terminal relative to the base station, the maximum Doppler frequency deviation will be ±fₘ, where +fₘ implies the mobile terminal is traveling towards the base station and −fₘ implies the mobile terminal is traveling away from the base station.

FIG. 1 is a plot of Doppler frequency shift versus mobile terminal velocity for a carrier frequency of 2 GHz . All the values are positive, implying that the mobile terminal is traveling toward the base station. The values would be negative if the mobile terminal traveled away from the base station. Typically, a high speed train travels between 200 km/h and 400 km/h, equating to a maximum Doppler frequency deviations of 370 Hz and 740 Hz, respectively. If these frequency shifts are not compensated in signal processing, then wireless communication performance can be degraded.

The maximum tolerable phase offset for digital modulation schemes such as M-ary Phase Shift Keying (MPSK), M∈(2,4,8) when operating under noise free conditions, is ±π/M. FIG. 2 illustrates an impact of a Doppler frequency shift on 2-ary PSK modulation. The diagram corresponds to the signal space for a 2-ary PSK modulation scheme. The signal space is complex: the vertical axis 201 corresponds to the imaginary component; and the horizontal axis 202 to the real component. If a continuous bit stream, corresponding to a constant modulation phase state of π/2, is transmitted, and the first modulation symbol 203 arrives at the receiver at the correct phase position of π/2, then the frequency offset in the channel causes subsequent modulation symbols to undergo a cumulative phase offset up to the last modulation symbol 204. This is illustrated in FIG. 2, which shows the phase trajectory 205 from first to the last modulation symbol.

From FIG. 2, the modulation symbol is deemed as being in error if the imaginary part of the complex modulation symbol is negative. One can see that the distance of the last modulation symbol, D2 (207), to the real axis is substantially less than the distance of the first modulation symbol, D1 (206), to the real axis, i.e., D1>D2. If the modulation symbols are corrupted by noise or interference, the probability that the last modulation symbol is in error will be higher than that of the first modulation symbol.

The foregoing illustrates that a Doppler frequency-shift mitigation scheme is required in communication systems with high mobility that employ digital modulation schemes.

### SUMMARY OF THE INVENTION

According to embodiments of the present invention, a coherent or a noncoherent transmission mode is automatically selected by a mobile terminal (UE) on the basis of an estimated Doppler frequency shift due to motion of a mobile terminal. Coherent transmission modes can offer superior noise performance than noncoherent modes, if sufficient pilot overhead is provided to mitigate frequency offsets. However, as the Doppler shift due to the mobile terminal velocity increases, the required pilot overhead can become substantial if link performance is to be maintained, reducing data throughput and system efficiency. For a given pilot overhead the link performance of a coherent scheme will degrade with increasing Doppler until noncoherent transmission schemes outperform coherent transmission schemes.

An embodiment of the invention is a method of selecting coherent or noncoherent transmission modes for a mobile terminal in a wireless communication system, comprising: estimating a Doppler frequency shift resulting from a motion of the mobile terminal relative to a base station; comparing the estimated Doppler frequency shift with a threshold value of Doppler frequency shift; and if the estimated Doppler frequency shift exceeds the threshold value, selecting a noncoherent transmission mode for the mobile terminal; otherwise, selecting a coherent transmission mode for the mobile terminal.

Other embodiments further comprise transmitting an indication of whether the coherent transmission mode or the noncoherent transmission mode is selected wherein the transmitted indication can be a single modulation symbol or a sequence of modulation symbols. In some embodiments, the Doppler frequency shift is estimated by comparing changes over time in the mobile terminal's geographic coordinates, as determined by a position location system in the mobile terminal, with a set of known geographic coordinates of a base station.

In another embodiment, a method of selecting coherent or noncoherent detection modes for a base station receiver in a wireless communication system, comprises: receiving an indication of whether a received wireless signal is encoded in a coherent or a noncoherent mode; and detecting the received wireless signal in the corresponding coherent or noncoherent mode, responsive to the received indication, wherein the transmitted indication can be a single modulation symbol or a sequence of modulation symbols.

A further embodiment is a method of selecting coherent or noncoherent detection modes for a base station receiver in a wireless communication system, comprising: receiving a wireless signal; detecting the wireless signal in a coherent mode; estimating a signal quality metric for the wireless signal that was detected in the coherent mode; detecting the wireless signal in a noncoherent mode; estimating a signal quality metric for the wireless signal that was detected in the noncoherent mode; and selecting the coherent mode detected wireless signal, or selecting the noncoherent mode detected wireless signal, for subsequent processing on the basis of which has the highest signal quality metric.

Additional embodiments of the invention comprise apparatus and computer-readable media comprising computer readable instructions for executing the above method embodiments, among others.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

FIG. 1 is an exemplary plot of Doppler frequency shift in Hertz versus a mobile terminal's speed.

FIG. 2 illustrates an impact of Doppler frequency shift on 2-ary PSK modulation.

FIG. 3 illustrates a method of estimating a Doppler frequency shift by phase perturbation, according to an embodiment of the invention.

FIG. 4A illustrates a pilot transmission overhead, along with a corresponding maximum phase rotation, for low Doppler frequency shifts, corresponding to moderate mobile terminal speeds, according to one embodiment of the invention.

FIG. 4B illustrates a pilot transmission overhead, along with a corresponding maximum phase rotation of high Doppler frequency shifts, corresponding to high mobile terminal speeds according to another embodiment of the invention.

FIG. 4C illustrates a continuous pilot transmission overhead, along with a corresponding maximum phase rotation of high Doppler frequency shifts, corresponding to high mobile terminal speeds at a first pilot averaging period according to another embodiment of the invention.

FIG. 4D illustrates a continuous pilot transmission overhead, along with a corresponding maximum phase rotation of high Doppler frequency shifts, corresponding to high mobile terminal speeds at a second, shorter pilot averaging period according to a further embodiment of the invention.

FIG. 5 is a plot of required signal-to-noise ratios as functions of Doppler frequency shift for coherent and noncoherent detection embodiments of the invention.

FIG. 6 shows a transmitter architecture according to an embodiment of the invention.

FIG. 7 shows a receiver architecture according to another embodiment of the invention.

FIG. 8 shows a receiver architecture according to a further embodiment of the invention.

FIG. 9 is a block diagram of a transceiver architecture according to an embodiment of the invention.

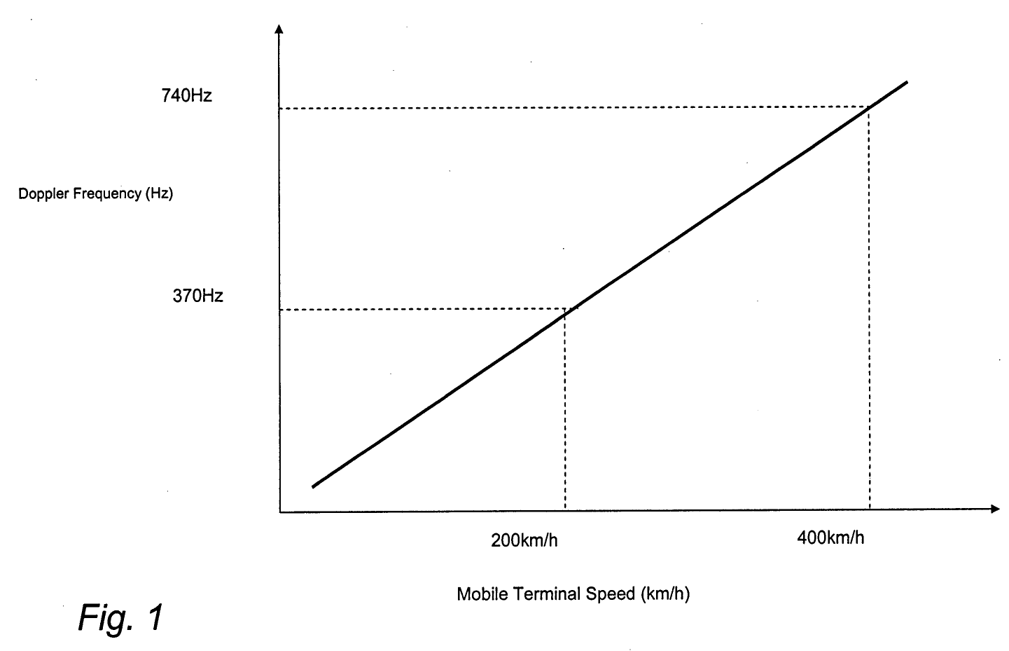

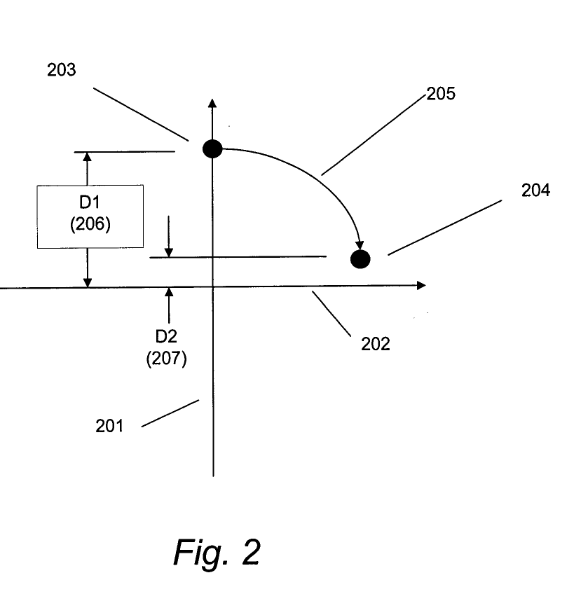

Commonly numbered drawing elements in the various figures refer to common elements of the embodiments of the invention. The drawings of the embodiments shown in the figures are not necessarily to scale. The drawings of the embodiments shown in the figures are for purposes of illustration only, and should not be construed to limit the scope of the invention.

### DETAILED DESCRIPTION OF THE INVENTION

In the following description, reference is made to the accompanying drawings which illustrate several embodiments of the present invention. It is understood that other embodiments may be utilized and mechanical, compositional, structural, electrical, and operational changes may be made without departing from the spirit and scope of the present disclosure. The following detailed description is not to be taken in a limiting sense, and the scope of the embodiments of the present invention is defined only by the claims of the issued patent.

Some portions of the detailed description that follow are presented in terms of procedures, steps, logic blocks, processing, and other symbolic representations of operations on data bits that can be performed on computer memory. A procedure, computer executed step, logic block, process, etc., are here conceived to be a self-consistent sequence of steps or instructions leading to a desired result. The steps are those utilizing physical manipulations of physical quantities. These quantities can take the form of electrical, magnetic, or radio signals capable of being stored, transferred, combined, compared, and otherwise manipulated in a computer system. These signals may be referred to at times as bits, values, elements, symbols, characters, terms, numbers, or the like. Each step may be performed by hardware, software, firmware, or combinations thereof.

Although the present invention is described herein in the context of an M-ary PSK digital modulation scheme, those skilled in the art will understand that the invention, including the concept of maximum tolerable phase offset, can also be applied to other modulation schemes such as, for example, quadrature amplitude modulation (QAM), and orthogonal frequency division multiplexing (OFDM).

Two techniques for mitigating frequency offsets can be used in embodiments of the invention: coherent detection and noncoherent detection.

Typically, cellular systems such as UMTS employ coherent detection for both uplink and downlink. In such embodiments, dedicated pilots or training sequences are transmitted with the data so as to facilitate the recovery of the modulated information. The pilot allows timing, phase, and frequency information to be determined.

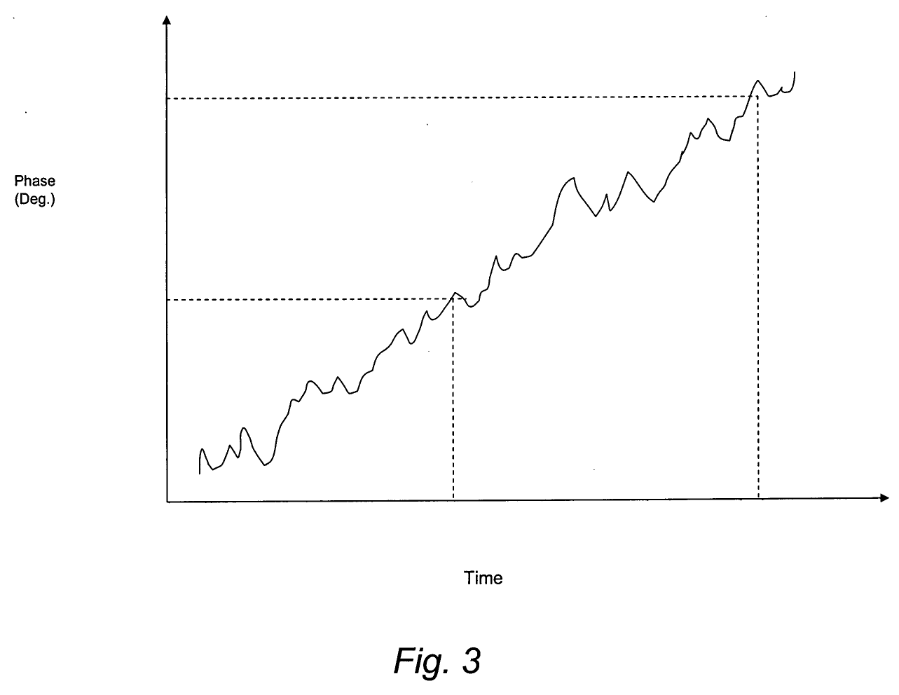

The process of estimating a Doppler frequency shift is illustrated in FIG. 3. When a mobile terminal travels toward a base station, a frequency offset appears as a phase ramp over time, defined by:
φ(t)=ωₘt (2)
where ωₘ=2πfₘ.
The phase frequency relationship is given by

$$\frac{ⅆ ϕ ( t )}{ⅆ t} = {ω}_{m} \qquad ( 3 )$$

In one embodiment, the frequency estimate is obtained by taking two or more samples of the carrier phase over time, for example:

$${\hat{f}}_{m} = \frac{1}{2 π} \times \frac{{ϕ}_{2} - {ϕ}_{1}}{{t}_{2} - {t}_{1}} \qquad ( 4 )$$

where φ₁ is a sample of the carrier phase at time t₁ and φ₂ is a sample of the carrier phase at time t₂. Obtaining φ₁ and φ₂ from the pilot sequences would be known to those skilled in the art. The minimum sampling rate of the frequency estimator can be 2×fₘ to uniquely estimate a Doppler frequency shift of fₘ. The relationship between estimating Doppler frequency shift, \hat{f}ₘ, and sample rate would be known to those skilled in the art, as would be the compensation of \hat{f}ₘ from the received signal.

According to Equation 1, the maximum Doppler frequency deviation is directly proportional to the velocity of the mobile terminal. If the Doppler frequency shift is to be uniquely characterized, then it follows that for an increase in maximum Doppler frequency, a corresponding increase in sample rate is necessary. This requirement directly translates as an increase in pilot overhead, i.e., more of the transmission payload has to be allocated to pilot symbols rather than data symbols. The result is a reduction in data throughput.

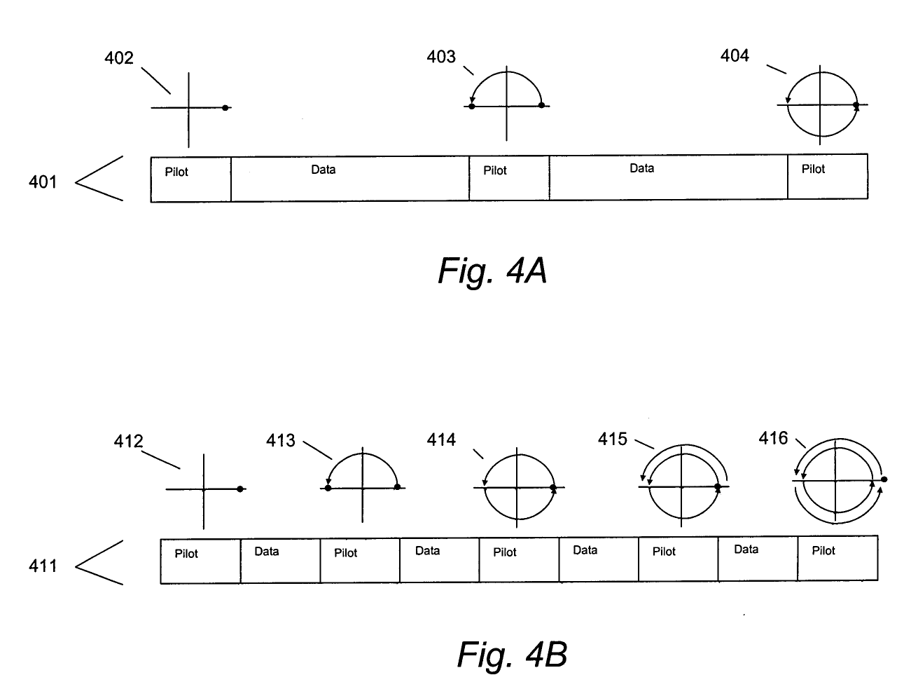

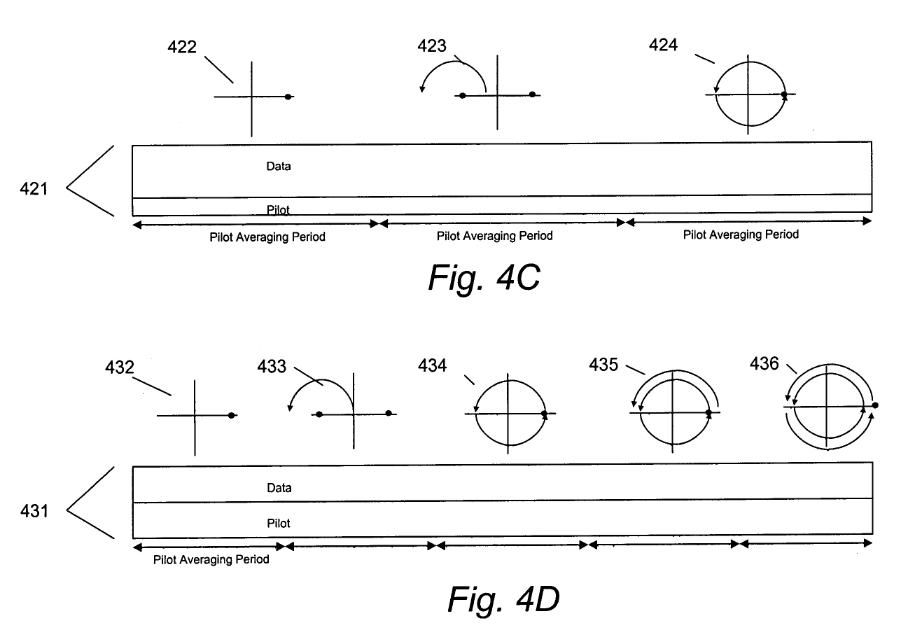

This is illustrated in FIGS. 4A and 4B. In FIG. 4A, the maximum phase shift due to Doppler frequency shift is π radians between pilots. In FIG. 4B, the maximum Doppler frequency shift has increased, but the number of pilots has also increased to accommodate this higher Doppler frequency shift. The phase shift between pilots in FIG. 4B is still π radians, but if one compares the phase shift of FIG. 4B with the pilot configuration of FIG. 4A one sees a 2π radians phase rotation between pilots. Clearly for this case, the pilots in FIG. 4A would be unable to uniquely resolve the frequency offsets in FIG. 4B. For FIG. 4B, the maximum shift between pilots is π radians to resolve the Doppler frequency shift. For coherent detection at high mobile terminal speeds, the burden of pilot overhead required for coherent detection can be prohibitive. This additional overhead reduces the data throughput. Although the pilot signals in FIG. 4A and FIG. 4B are shown to be interleaved, it will be understood that a similar interpretation can be applied to a system where the pilot is transmitted continuously and the carrier phase estimates are achieved by averaging the carrier over time. Averaging is required in order to accumulate sufficient energy from the pilot in order to form a sufficiently accurate estimate of the carrier phase. Higher Doppler shifts can be supported by shortening the averaging time, however in order to achieve the same accuracy, the proportion of the signal power assigned to the pilot will need to increase and consequently, the system resource available for data transmission is reduced. This is illustrated in FIGS. 4C and 4D.

Noncoherent detection schemes do not recover the carrier phase information, but instead rely on encoding in the modulated signal to remove any phase perturbations that are generated by the propagation channel.

In one embodiment, 4-ary symbols are encoded according to the following rule
cₖ=cₖ₋₁+bₖ mod 4, k=(1,2,3, . . . ,N) (5)
where bₖ∈(0,1,2,3), bₖ=2a₂ₖ₋₁+a₂ₖ, N is the number of symbols, and aᵢ∈(0,1) are the data bits. A complex modulation symbol is given by
uₖ=j^{c}^{ₖ} (6)
where j=\sqrt{−1}. For convenience we describe the received signal at the antenna as
yₖ=uₖe^{jθ}^{ₖ}+nₖ (7)
where e^{jθ}^{ₖ} is the complex term arising from the Doppler frequency deviation, and nₖ is a complex noise term. The output of the noncoherent detector is given by
ûₖ=yₖy*ₖ₋₁ (8)
Substituting (7) into (8) gives
ûₖ=uₖu*ₖ₋₁e^{j(θ}^{ₖ}^{-θ}^{_{k−1}}+zₖ+nₖn*ₖ₋₁ (9)
where
zₖ=nₖuₖ₋₁e^{-jθ}^{_{k−1}}+nₖ₋₁uₖe^{jθ}^{ₖ} (10)
The modulation symbol estimate consists of 3 terms, the wanted term uₖu*ₖ₋₁e^{j(θ}^{ₖ}^{-θ}^{_{k−1}}⁾, a correlated noise term zₖ which is a function of the data and the Doppler frequency deviation, and a weak noise term nₖn*ₖ₋₁. When the wanted component is much larger than the noise components, the estimate of the modulation symbol estimate is given by
û≈uₖu*ₖ₋₁e^{j(θ}^{ₖ}^{-θ}^{_{k−1}}⁾ (11)
Clearly, if the phase shift between modulation symbols due to a Doppler frequency shift is small, the impact on performance is negligible, and we can write
ûₖ≈uₖu*ₖ₋₁ (12)

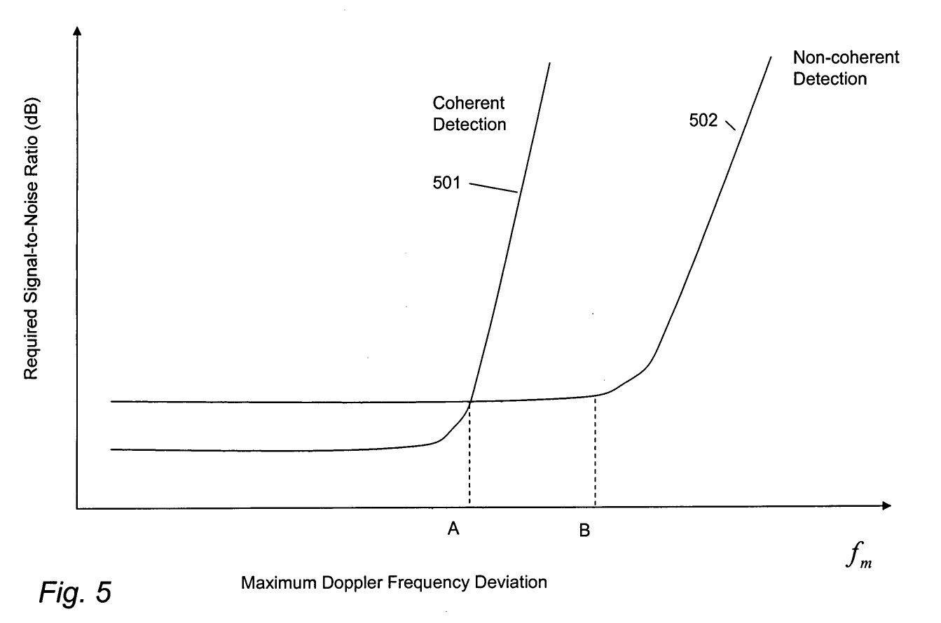

A drawback with noncoherent schemes is the correlated noise term zₖ. When compared to coherent schemes, the performance of noncoherent schemes is worse because of zₖ. The difference in performance as a function of maximum Doppler frequency deviation is illustrated in FIG. 5. FIG. 5 shows the signal-to-noise ratio required to achieve a target error rate performance for both coherent 501 and noncoherent 502 detection schemes. For fₘ<A the coherent detection scheme out performs the noncoherent detection scheme. When fₘ>A, the noncoherent detection scheme outperforms the coherent detection scheme. The maximum Doppler frequency shift at which this occurs is a function of the pilot overhead as discussed in the previous section. A high pilot overhead means the crossover point between coherent and non-coherent detection will be much closer to point B in the graph. This is at the expense of data throughput. A low pilot overhead means that the crossover point will be at lower values of maximum Doppler frequency shift. For noncoherent schemes, point B is related to the symbol rate, therefore in order for coherent schemes to approach the Doppler tolerance exhibited by noncoherent schemes, the pilot overhead needs to approach the symbol rate.

In summary, coherent schemes perform better than noncoherent schemes, if sufficient pilot overhead is provided to mitigate frequency offsets. However, as the velocity increases the pilot overhead can become substantial. The result is a reduction in data throughput. Noncoherent schemes do not require pilots to cope with frequency offsets; instead they employ encoding to overcome frequency offsets. This encoding means a reduction in performance relative to coherent schemes. However, when the pilot overhead is unable to resolve the frequency offset, non-coherent schemes outperform coherent schemes.

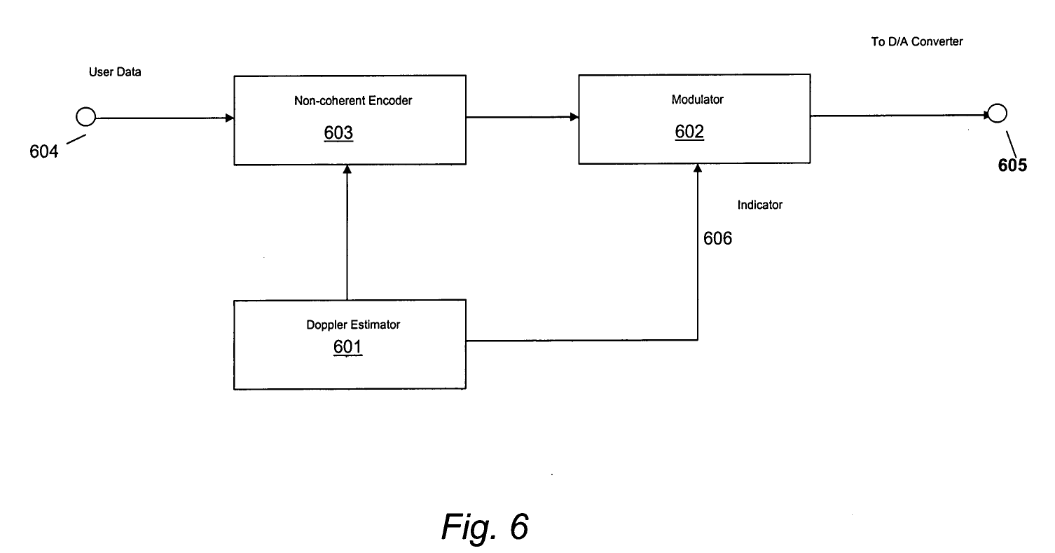

Coherent detection outperforms noncoherent detection provided that pilot sequences are transmitted at sufficiently small intervals. However pilot sequences occupy physical resources that might otherwise be used for transmitting data. Therefore, once the mobile terminal's speed exceeds a certain threshold, it is advantageous to switch to noncoherent transmission . A block diagram of a transmitter is shown below in FIG. 6. It consists of a Doppler estimator 601, an encoder 603, a modulator 602 and an indicator 606.

In one embodiment, the transmitter autonomously decides whether or not to apply noncoherent encoding. The Doppler estimator determines the frequency offset due to the movement of the mobile terminal. An embodiment for the Doppler estimator at a mobile terminal can use a position location system receiver to compare the changes over time in the geographic coordinates of a mobile terminal to determine a movement of the mobile terminal relative to a base station having known geographic coordinates. Examples of such position location systems include, without limitation: (i) Global Positioning System (GPS), (ii) LORAN, and (III) GLONASS. Some wireless communication systems can allow mobile terminals to estimate their positions based on time differences of arrival (TDOA) for downlink signals received from multiple base stations. TDOA can also be applied to uplink signals from a mobile terminal that are received by multiple base stations. Still other methods may combine various aspects of the above mentioned position location systems and method. It is also understood by those skilled in the art that numerous other techniques exist for estimating relative velocity or Doppler shift directly.

The Doppler shift estimator enables the transmitter to make a decision as to whether noncoherent encoding should be applied to the UE transmissions. If the estimated Doppler shift is greater than a defined threshold, the noncoherent encoder is enabled in the transmitter. If the estimated Doppler shift is less than the threshold then the noncoherent encoder is transparent.

Since the UE transmitter autonomously makes a decision, it needs to inform the base station receiving equipment whether or not noncoherent encoding has been applied to the transmissions. Therefore, the invention includes a function within the Doppler shift estimator 601 that inserts an indicator into the transmitted signal. This is shown as an input into the modulator block 602 in FIG. 6. It is also understood that the receiving equipment could also autonomously detect the use of noncoherent encoding at the transmitter. It is understood by those skilled in the art that one technique of noncoherent encoding is differential encoding. Here the phase difference between subsequent modulation symbols is encoded. This can be considered as an accumulation of the phase difference.

In one embodiment the indicator is a single modulation symbol that is always encoded, or in other embodiments it could be a predefined sequence of modulation symbols. Either way, an indicator definition is known at the receiving side. In preferred embodiments, the indicator should have sufficient protection to enable it to operate under high values of Doppler frequency shift.

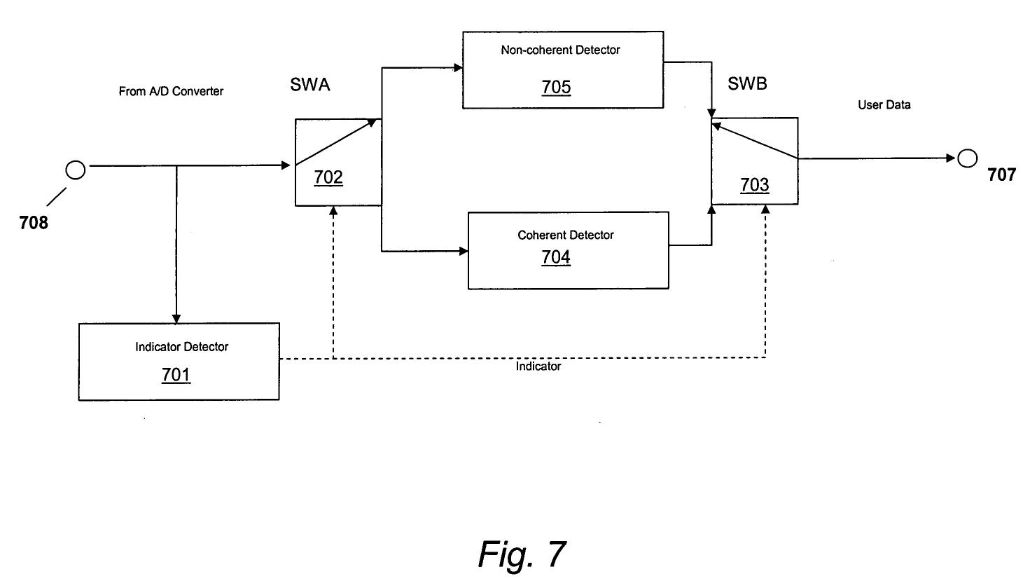

In an exemplary embodiment, the base station receiving equipment of the invention is illustrated in FIG. 7. The indicator is detected by the indicator detector block 701. Based on the recovered indicator value either coherent or noncoherent detection is applied. Switches SWA 702 and SWB 703 are synchronized so that if the indicator indicates noncoherent encoding is disabled, the estimated symbols are taken from the coherent detection block 704, and similarly if the indicator indicates that noncoherent encoding is enabled, the estimated symbols are taken from the noncoherent detection block 705.

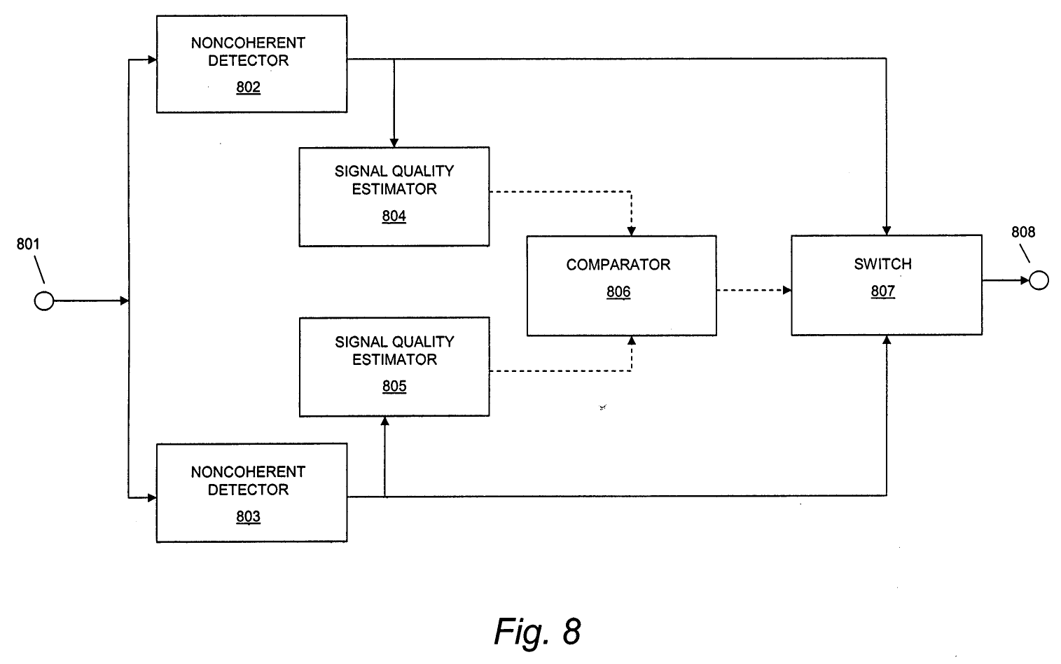

In another embodiment, shown in FIG. 8, noncoherent detector 803 and coherent detector 802 can both attempt to detect the same received wireless signal 801. Respective signal quality metrics can be estimated for both of the detected signals using signal quality estimates (805 and 804). The outputs of the signal quality estimators can then be sent to comparator 806 that actuates switch to select the signal with the highest perceived quality, to pass on for subsequent processing 808.

Although FIGS. 7 and 8 show various functions as different functional blocks, in other embodiments functions of different functional blocks can be performed by common digital circuitry, or a microprocessor or a digital signal processor under software control.

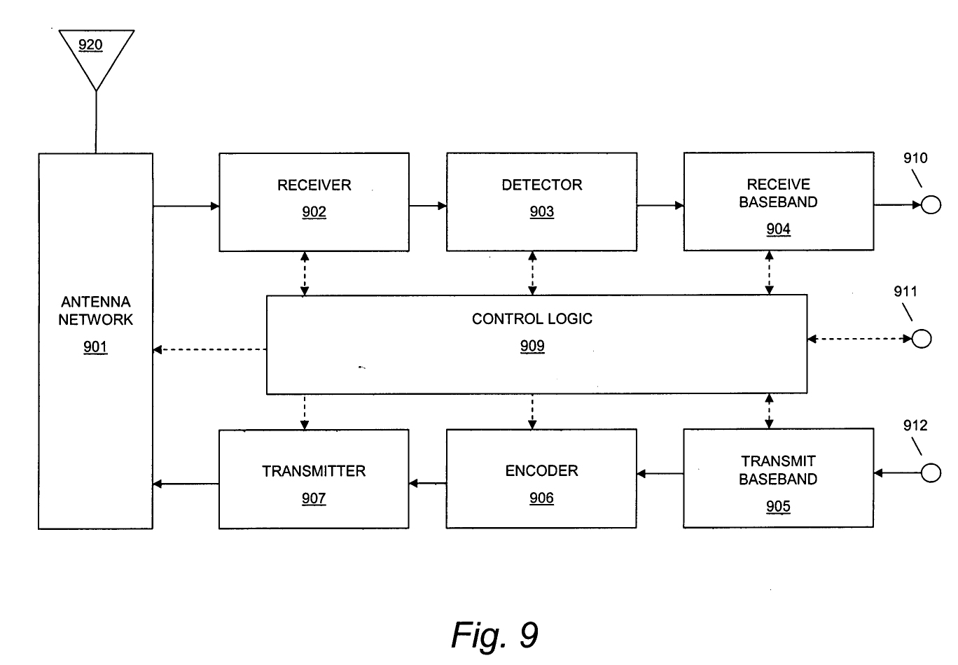

FIG. 9 is a block diagram of a wireless transceiver that can apply to either a mobile terminal or a base station according to embodiments of the invention. Antenna network 901 couples antenna 920 to both receiver 902 and transmitter 907. A purpose of antenna network 901 is to enable both receiver 902 and transmitter 907 to share common antenna 920. Another purpose of antenna network 901 can be to provide filtering for the transmission and reception of wireless signals. Still another purpose of antenna network 901 can be to provide isolation of transmitter 907 to reflected transmitted signals. Antenna network 901 can comprise a duplex filter for frequency division duplex (FDD) system, or it can comprise a transmit/receive (T/R) switch (with or without RF filtering) for a time division duplex (TDD) system. The T/R switch state would be synchronized with transmission and reception by operably connected control logic 909. In another embodiment, antenna network 901 can comprise a circulator, with or without RF filtering.

Receiver 902 can include circuitry for one or more of the following functions: radio frequency (RF) filtering; intermediate frequency (IF) filtering; RF amplification; IF amplification; local oscillator(s) or frequency synthesizer(s); frequency converters; baseband filtering; baseband amplification; power level detection; and analog to digital conversion. The output of receiver 902 is operably connected to detector 903. Detector 903 can be an analog or a digital circuit. Detector 903 is where coherent or noncoherent detection occurs. Some embodiments of detector 903 are illustrated in FIGS. 7 and 8. Most commonly, detector 903 is implemented with digital circuitry in modem systems, the analog to digital conversion having been provided in receiver 902. The output of detector 903 is operably coupled to receive baseband circuitry 904, that can performs additional functions such as filtering, timing recovery, error control decoding, format conversion, and so forth to that the received data can be forwarded to node 910 for subsequent processing.

Transmit baseband circuit 905 is operable to receive data input from data input port 912. Transmit baseband circuit 905 can perform functions such as formatting, coding, interleaving, insertion of control data, and so forth. The output of transmit baseband circuit 905 is typically digital in modern systems and is operably connected to the input of encoder 906. FIG. 6 illustrates an embodiment of encoder 906. Encoder 906 can coherently or noncoherently encode data for transmission and optionally insert an indication of the type of encoding being used according to various embodiments of the invention. Encoder 906 can also modulate the data for transmission either before and/or after digital to analog conversion. Modern systems often include digital to analog conversion in encoder 906. Encoder 906 can also provide digital, and/or analog signal filtering and conditioning.

Transmitter 907 can take an analog output from encoder 906 and can include circuits to perform one or more of the following functions: IF filtering; RF filtering; IF gain; RF gain; RF power level detection; frequency conversion; and local oscillators and/or frequency synthesizers. Often, local oscillators and/or frequency synthesizers are shared between transmitters and receivers.

Control logic 909 monitors and controls the operation of the various functions of the transceiver responsive to control inputs from port 911. Often, control logic 909 is implemented using the same digital circuitry that comprises transmit baseband 905 and receive baseband 904. Sometimes this circuitry also comprises at least portions of detector 903 and encoder 906.

The figures provided are merely representational and may not be drawn to scale. Certain proportions thereof may be exaggerated, while others may be minimized. The figures are intended to illustrate various implementations of the invention that can be understood and appropriately carried out by those of ordinary skill in the art.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

1. A method of selecting coherent or noncoherent transmission modes for a mobile terminal in a wireless communication system, comprising:
estimating a Doppler frequency shift resulting from motion of the mobile terminal relative to a base station;
comparing the estimated Doppler frequency shift with a threshold value of Doppler frequency shift; and
if the estimated Doppler frequency shift exceeds the threshold value, selecting a noncoherent transmission mode for the mobile terminal;
otherwise selecting a coherent transmission mode for the mobile terminal.

2. The method of claim 1, further comprising transmitting an indication of whether the coherent transmission mode or the noncoherent transmission mode is selected.

3. The method of claim 2, wherein the transmitted indication is a single modulation symbol.

4. The method of claim 2, wherein the transmitted indication is a sequence of modulation symbols.

5. The method of claim 1, wherein the Doppler frequency shift is estimated by comparing changes over time in the mobile terminal's geographic coordinates, as determined by a position location system receiver in the mobile terminal, with a set of known geographic coordinates of a base station.

6. A method of selecting coherent or noncoherent detection modes for a base station receiver in a wireless communication system, comprising:
receiving an indication of whether a received signal is encoded in a coherent or a noncoherent mode; and
detecting the received signal in the corresponding coherent or noncoherent mode, responsive to the received indication.

7. The method of claim 6, wherein the received indication is a single modulation symbol.

8. The method of claim 6, wherein the received indication is a sequence of modulation symbols.

9. A method of selecting coherent or noncoherent detection modes for a base station receiver in a wireless communication system, comprising:
detecting a wireless signal in a coherent mode;
estimating a signal quality metric for the wireless signal that was detected in the coherent mode;
detecting the wireless signal in a noncoherent mode;
estimating a signal quality metric for the wireless signal that was detected in the noncoherent mode; and
selecting the coherent mode detected wireless signal, or selecting the noncoherent mode detected wireless signal, for subsequent processing on the basis of which has the higher estimated signal quality metric.

10. A computer-readable medium comprising computer-executable instructions for performing a method of selecting coherent or noncoherent transmission modes for a mobile terminal transmitter for a wireless communication system, comprising:
estimating a Doppler frequency shift resulting from a motion of a mobile terminal;
comparing the estimated Doppler frequency shift with a threshold value of Doppler frequency shift; and
if the estimated Doppler frequency shift exceeds the threshold value, selecting a noncoherent transmission mode; otherwise,
selecting a coherent transmission mode.

11. The computer-readable medium of claim 10, wherein the Doppler frequency shift is estimated by comparing changes over time in the mobile terminal's geographic coordinates, as determined by a position location system receiver in the mobile terminal, with a set of known geographic coordinates of a base station.

12. The computer-readable medium of claim 10, further comprising computer-executable instructions to transmit an indication of whether a coherent or a noncoherent transmission mode is selected.

13. The computer-readable medium of claim 12, wherein the transmitted indication is a single modulation symbol.

14. The computer-readable medium of claim 12, wherein the transmitted indication is a sequence of modulation symbols.

15. A computer-readable medium comprising computer-executable instructions for performing a method of selecting coherent or noncoherent detection modes for a wireless communication system base station receiver, comprising:
receiving an indication of whether a coherent or a noncoherent transmission mode has been selected; and
detecting the wireless signal in the corresponding coherent or noncoherent mode, responsive to the received indication.

16. The computer-readable medium of claim 15, wherein the received indication is a single modulation symbol.

17. The computer-readable medium of claim 15, wherein the received indication is a sequence of modulation symbols.

18. A computer-readable medium comprising computer-executable instructions for performing a method of selecting coherent or noncoherent detection modes for a base station in a wireless communication system, comprising:
detecting a signal in a coherent mode;
estimating a signal quality metric for the signal that was detected in the coherent mode;
detecting the signal in a noncoherent mode;
estimating a signal quality metric for the signal that was detected in the noncoherent mode; and
selecting the coherent mode detected signal, or selecting the noncoherent mode detected signal, for subsequent processing on the basis of which has the higher signal quality metric.

19. A mobile terminal transmitter for a wireless communication system, capable of selecting coherent or noncoherent transmission modes, comprising:
a Doppler frequency shift estimator operable to estimate a Doppler frequency shift resulting from motion of the mobile terminal relative to a base station;
a selector operable to select a noncoherent transmission mode for the mobile terminal if the estimated Doppler frequency shift exceeds a threshold Doppler frequency shift value; and operable to select a coherent transmission mode for the mobile terminal, otherwise.

20. The mobile terminal transmitter of claim 19, wherein the Doppler frequency shift estimator is operable to compare changes over time in the mobile terminal's geographic coordinates, as determined by a position location system receiver in the mobile terminal, with a set of known geographic coordinates of a base station to determine a relative motion of the mobile terminal and the base station.

21. The mobile terminal transmitter of claim 19, further comprising an encoder operable to encode at least one modulation symbol to indicate whether a noncoherent mode or a coherent mode of transmission has been enabled.

22. A base station receiver for a wireless communication system, comprising:
a receiver operable to receive a wireless signal;
a received signal transmission mode detector operable to determine whether the received wireless signal has noncoherent encoding or coherent encoding;
a noncoherent detector;
a coherent detector; and
a switch operable to send a received signal to the noncoherent detector or to the coherent detector, responsive to the received signal transmission mode detector.

23. A base station receiver for a wireless communication system, comprising:
a receiver operable a wireless signal;
a noncoherent detector operable to detect the signal in a noncoherent mode operably connected to the receiver;
a coherent detector operable to detect the signal in a coherent mode operably connected to the receiver; and
a signal quality estimator operable to estimate a signal quality metric for the wireless signal detected in the noncoherent mode operably connected to the noncoherent detector;
a signal quality estimator operable to estimate a signal quality metric for the wireless signal detected in the noncoherent mode operably connected to the coherent detector; and
a switch operable to select the wireless signal detected in the noncoherent mode or for selecting the wireless signal detected in the coherent mode on the basis of which has the higher quality metric.
